(19) United States
(12) Patent Application Publication
(10) Pub. No.: US 2004/0076398 A1
(43) Pub. Date: Apr. 22, 2004

(54) Electronic Album

(75) Inventor: Shao-Ming Chai, Hsinchu (TW)

Correspondence Address: TROXELL LAW OFFICE PLLC, 5205 LEESBURG PIKE, SUITE 1404, FALLS CHURCH, VA, 22041, US

(73) Assignee: ENE Technology Inc.

(21) Appl. No.: 10/419,824

(22) Filed: Apr. 22, 2003

(30) Foreign Application Priority Data
Oct. 16, 2002 (TW) 091123862

(51) Int. Cl. H04N 5/76; H04N 5/781

(52) U.S. Cl. 386/46; 386/125

(57) ABSTRACT

An electronic album includes a control chip in a computer monitor to couple the existing computer monitor with a general conventional image storage media device used in general digital cameras to directly display images stored in the image storage media device on the screen to achieve objects and functions of economy, simplicity, convenience and portability.

### BACKGROUND OF THE INVENTION

1. Field of the Invention

The invention relates to an electronic album (E-album) that has a control chip to couple with an existing computer monitor and a general conventional image storage media device to directly display images stored in the storage media device on the screen to achieve the objects and functions of economy, simplicity, convenience and portability.

2. Description of the Prior Art

The conventional techniques for displaying or browsing digital images generally employ software in personal computers. FIG. 1 illustrates a digital camera connecting to a personal computer adopted in conventional techniques. The still or video digital images captured by the digital camera 11 are transmitted to a memory device 17 in the computer processor 13 through a transmission line 19, and the image files are decompressed or decoded by the central processor. Then a related displaying software retrieves the digital images from the memory device 17 and displays the images on the screen of a monitor 15 for viewing.

Refer to FIG. 2 for a conventional image storage media reader. There is a conventional portable image storage media device 23 which can read images from a digital camera. A computer processor 13 connects to a reader 21 to directly store the digital images in the image storage media device 23. Then a display software may be used to display the image files on the monitor 15 or store the image files into a memory device 17 of the computer processor 13 for viewing separately.

All aforesaid conventional techniques need a computer processor 13 to store the digital images and the screen of a monitor 15, and to couple with an image display software and computer operating system to view the images.

### SUMMARY OF THE INVENTION

The objects of the invention are to improve the foregoing complicated method of viewing digital images through the computer and to provide an electronic album (E-album) that has a control chip located in a computer monitor to enable users to directly see the digital images on the screen.

The E-album according to the invention has a control chip located in a computer monitor that includes an image storage media device controller for controlling access of the images, a power management unit for managing power supply, a frame buffer memory controller for controlling buffers, a connection device controller for controlling the connected external image storage media devices, a digital signal processor for transforming digital image signals to an image formation mode of the computer screen, a inter-IC bus for connecting to a microprocessor that processes control signals, a digital video signal output port and a multiplexer.

By coupling the elements in the aforesaid chip with the computer monitor and an image storage media device that is used in conventional digital cameras, an E-album is formed and can directly display the digital images stored in the storage media device on the screen, and achieve the objects and functions of economy, simplicity, convenience and portability.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a schematic view of a conventional technique that connects a digital camera to a computer processor.

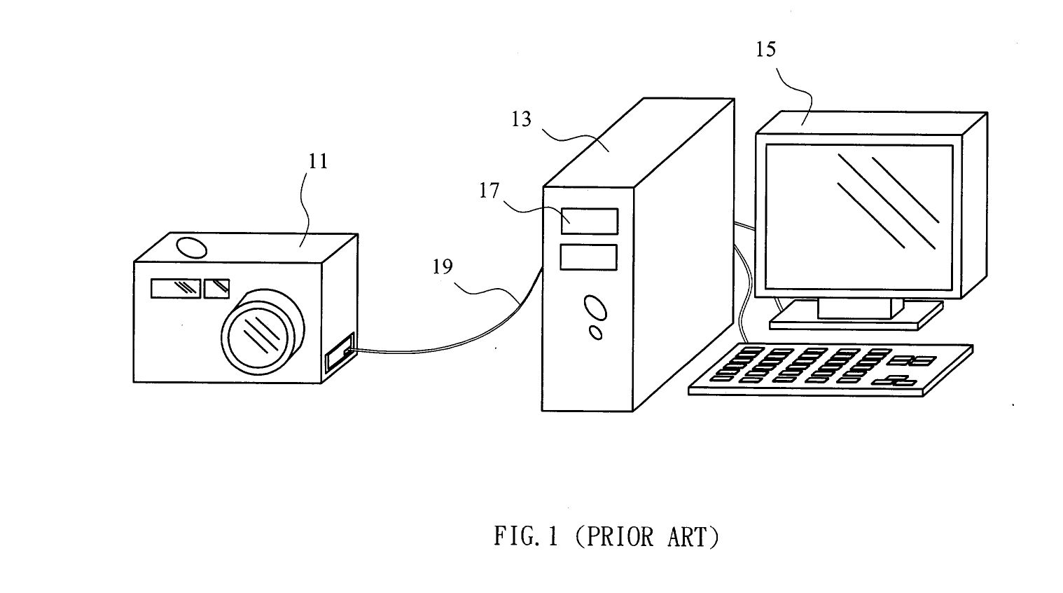

FIG.2 is a schematic view of a conventional reader for reading digital storage media devices.

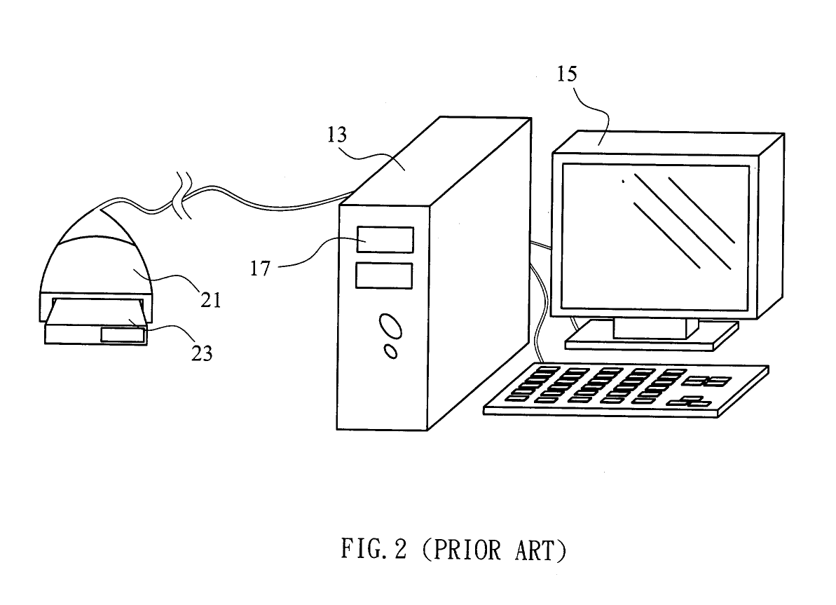

FIG. 3 is a schematic view of the invention for an image storage media device adopted on a computer monitor.

FIG. 4 is a structural block diagram of the control chip of the E-album according to an embodiment of the invention.

FIG. 5 is a structural block diagram of a control chip for analog signal input of the E-album of an embodiment of the invention.

FIG. 6 is a structural block diagram of a control chip for digital signal input of the E-album of an embodiment of the invention.

### DESCRIPTION OF THE PREFERRED EMBODIMENTS

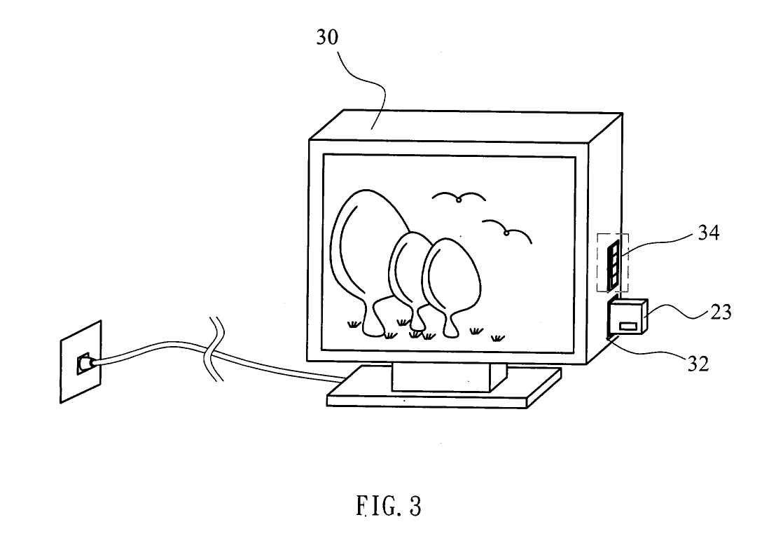

Refer to FIG. 3 for an embodiment of the invention with an image storage media device adopted on the computer monitor. A storage media reader 32 is built in a computer monitor 30. The insert slot of the storage media reader 32 is located on the casing of the computer monitor 30 for directly reading a general image storage media device 23 that stores images (including but not limited to Smart Media, Memory Stick, Multimedia Card, Secure Digital, Compact Flash, or the like, and supporting formats including but not limited to JPEG, TIFF, BMP, GIF, PNG or the like). And through operations on a digital control panel 34, digital image files stored in the storage media device 23 may be displayed on the computer monitor 30. The display formats include but not limited to slide show, thumbnails, still, and fade in/out to achieve the function of the E-album.

The following is the detail explanation of the structure of the E-album control chip built in the computer monitor 30.

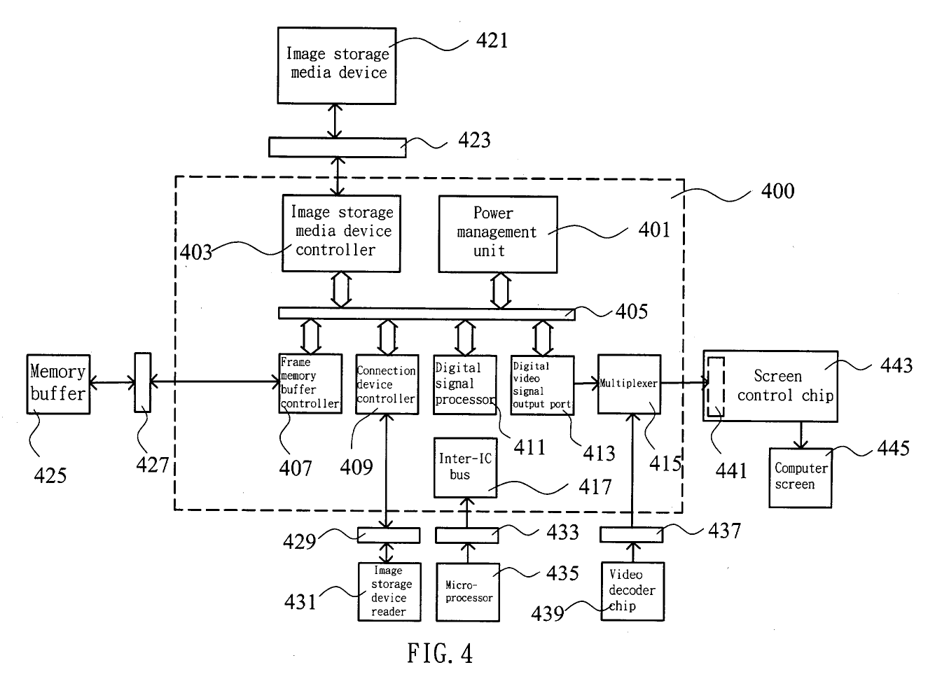

Refer to FIG. 4 for the structural block diagram of the control chip of the E-album according to an embodiment of the invention. The module of an, E-album control chip 400 includes a bus 405 connecting to a power management unit 401, an image storage media device controller 403, a frame buffer memory controller 407, a connection device controller 409, a digital signal processor 411 and a digital video signal output port 413. There is also a multiplexer 415 connecting to the digital video signal output port 413, and a built-in inter-IC bus 417.

The power management unit 401 manages power utilization of various units in the E-album 400 including to detect whether the computer monitor is connected to a personal computer. If yes, the management chip sets power supply in a standby and power-saving mode; if no personal computer is connected, the power supply is set in a standalone mode. When an image storage media device 421 is connected or an image storage device reader 431 is connected through a connection port interface 429, the read memory and memory buffer 425 are connected and their power supply also is managed by the power management unit 401.

The digital signal processor 411 processes and decompresses the digital image files transmitted to the E-album control chip 400, including transforming the digital image files transmitted from various image storage media devices to RGB (Red, Green, Blue) or YUV display images, and processes memory exchange storing through the memory buffer 425.

Various images are sent to the computer screen 445 to form pictures through the digital video signal output port 413 and an image formation interface 441. The following is the connection structure of the E-album control chip 400 connecting to external devices through a plurality of interfaces.

The image storage media device controller 403 in the E-album control chip 400 is connected to an image storage media device 421 through a storage media device interface 423. A conventional image storage card such as Smart Media, Memory Stick, Multimedia Card, etc is used. The digital image files in the image storage media device 421 are retrieved through the storage media device interface 423 which is located on the casing of the computer monitor.

The frame buffer memory controller 407 is connected to the memory buffer 425 through a memory interface 427. The memory buffer 425 is a frame buffer for the E-album control chip 400 to read picture files.

The connection device controller 409 is connected to the image media device reader 431 through a connection port interface 429 which is a general USB or serial port to enable the E-album of the invention to have desired expandability to connect external image media device readers 431 to access contents in more image storage devices.

The inter-IC bus 417 is connected to a microprocessor 435 through a inter-IC bus interface 433. Control signals from the control panel of the computer monitor are processed by the microprocessor 435, then are transmitted to the E-album control chip 400 through the inter-IC bus interface 433.

The multiplexer 415 is connected to a video decoder chip 439 through a video decoder interface 437. Video signals are decoded and sent to the E-album control chip 400 through the video decoder interface 437, then are sent through the multiplexer 415 and an image formation interface 441 to the computer screen 445 to form pictures to enable the computer screen 445 to display TV signals in the embodiment of the invention.

The multiplexer 415 also connects to a screen control chip 443 through the image formation interface 441 and connects to the computer screen 445 after the signals have been processed. The digital images that are processed by the E-album control chip 400 and displayed on the computer screen 445 may come from the image storage media device 421, external image media device reader 431 and TV pictures processed by the Video decoder chip 439.

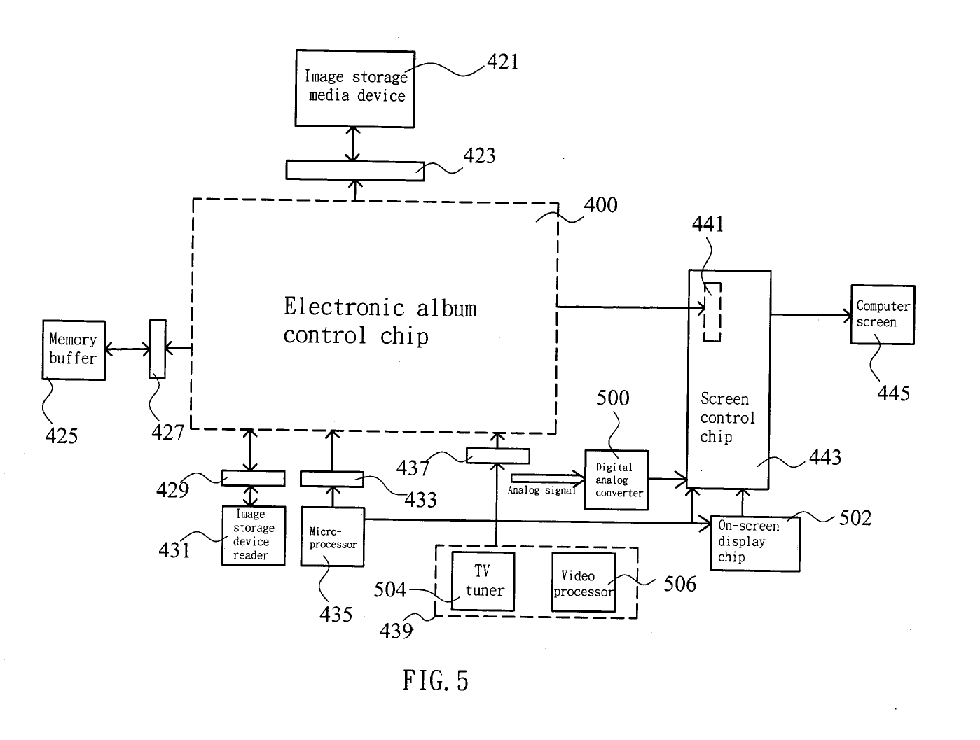

Refer to FIG. 5 for the structural block diagram of the control chip for analog signal input of the E-album according to an embodiment of the invention. The microprocessor 435 receives the commands entered by users from the digital control panel on the computer monitor, i.e. the digital control panel 34 shown in FIG. 3. An on-screen display 502 receives the control signals from the microprocessor 435 to control the picture formation condition of the digital images from the image storage media device 421 on the computer screen 445. In addition, the video decoder chip 439 further includes a TV tuner 504 and a video processor 506 for processing TV signals. The processed TV signals are transferred to the E-album control chip 400 through the video decoder interface 437, and through a screen control ship 443 to the computer screen 445 for displaying. Thus the computer monitor also has capability to broadcast TV pictures.

The digital-analog converter (ADC) 500 shown in FIG. 5 also may connect to analog signals of an external computer and convert the analog signals to digital signals, and send to the screen control chip 443 to directly display pictures on the computer screen 445 through a D-sub connector. In the event that the analog signals are not from the external computer processor, they are switched to the analog signals of general external devices and the digital pictures are displayed on the computer screen 445.

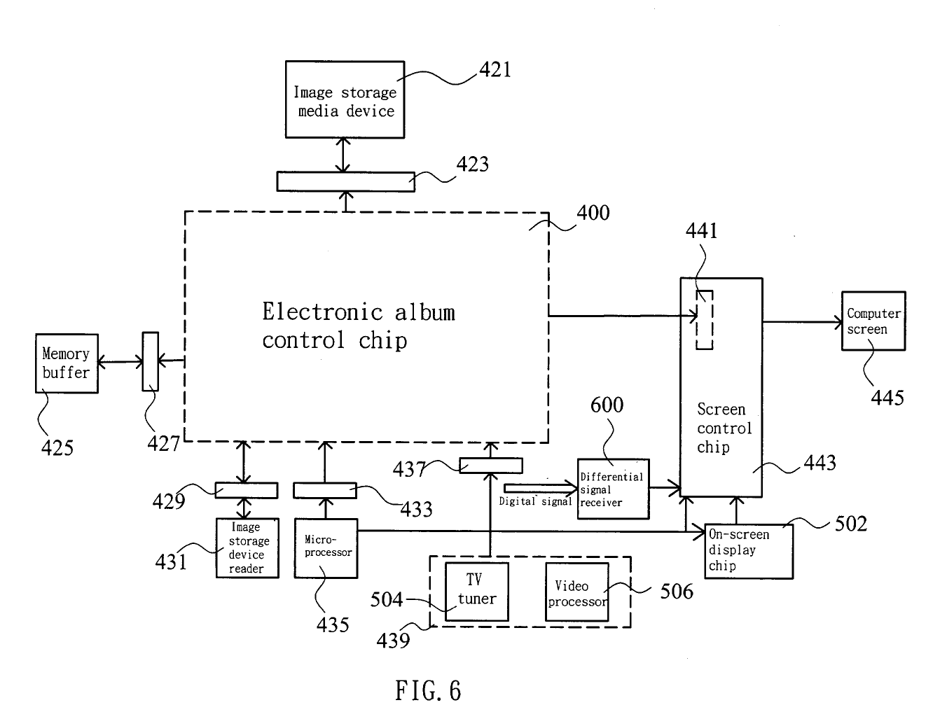

Refer to FIG. 6 for the structural block diagram of the control chip for digital signal input of the E-album according to another embodiment of the invention. The video decoder chip 439 includes a TV tuner 504 and a video processor 506. TV signals are processed by the TV tuner 504 and the video processor 506, then are transmitted to the E-album control chip 400 through a video decoder interface 437, then are sent to the computer screen 445 through the screen control chip 443 to display so that the TV monitor may also have the capability to broadcast TV pictures. Moreover, an external digital input signal may also be connected. The digital image signals are sent to the screen control chip 443 through a differential signal receiver 600 to directly form picture display on the computer screen 445. The differential signals received by the differential signal receiver 600 include transmission-minimized differential signaling (TMDS) or low-voltage differential signaling (LVDS).

By means of the construction and embodiments of the E-album set forth above, the invention includes a built-in E-album control chip in a general computer screen to read digital images stored in a general image storage media device, and can display pictures on the computer screen independent of the personal computer, thereby achieves the objects of economy, simplicity, convenience and portability.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

I claim:

1. An electronic album comprising an electronic album control chip installed in a conventional computer screen for displaying digital images, wherein the electronic album control chip includes:
an image storage media device controller for controlling image reading of an image processing device;
a power management unit for controlling power utilization in the electronic album control chip;
a frame buffer memory controller for controlling a connected buffer memory that retrieves image files;
a connection device controller controlling an external image storage device reader;
a digital signal processor for decompressing digital images in the electronic album control chip and converting to a picture formation mode for the computer screen;
a inter-IC bus connecting to an external microprocessor for processing control signals;
a digital video signal output port for outputting image files in the electronic album control chip; and
a multiplexer for receiving signals from a video decoder chip and output signals from the digital video signal output port, and connecting to a screen control chip for displaying pictures on the computer screen.

2. The electronic album of claim 1, wherein the image storage media device controller connects to the image processing device through a storage media device interface,

3. The electronic album of claim 1, wherein the frame buffer memory controller connects to the buffer memory through a memory interface.

4. The electronic album of claim 1, wherein the connection device controller connects to the image storage device reader through a connection port interface.

5. The electronic album of claim 1, wherein the inter-IC bus connects to the microprocessor through a inter-IC bus interface.

6. The electronic album of claim 1, wherein the multiplexer connects to the video decoder chip through a video decoder interface.

7. The electronic album of claim 1, wherein the multiplexer connects to the screen control chip through an image formation interface and further connects to the computer screen.

8. The electronic album of claim 2, wherein the storage media device interface is located on the casing of a computer monitor.

9. A electronic album comprising an electronic album control chip installed in a conventional computer screen for processing analog signals and displaying digital images, wherein the electronic album control chip includes:
an image storage media device controller for controlling image reading of an image processing device;
a power management unit for controlling power utilization in the electronic album control chip;
a frame buffer memory controller for controlling a connected buffer memory that retrieves image files;
a connection device controller controlling an external image storage device reader;
a digital signal processor for decompressing digital images in the electronic album control chip and converting to a picture formation mode for the computer screen;
a inter-IC bus connecting to an external microprocessor for processing control signals;
a digital video signal output port for outputting image files in the electronic album control chip;
a multiplexer for receiving signals from a video decoder chip and output signals from the digital video signal output port, and connecting to a screen control chip for displaying pictures on the computer screen;
a on-screen display chip for receiving control signals from the microprocessor and transmitting the signals to a screen control chip; and
a digital analog converter for receiving analog signals and converting the analog signals to digital signals.

10. The electronic album of claim 9, wherein the image storage media device controller connects to the image processing device through a storage media device interface,

11. The electronic album of claim 9, wherein the frame buffer memory controller connects to the buffer memory through a memory interface.

12. The electronic album of claim 9, wherein the connection device controller connects to the image storage device reader through a connection port interface.

13. The electronic album of claim 9, wherein the inter-IC bus connects to the microprocessor through a inter-IC bus interface.

14. The electronic album of claim 9, wherein the multiplexer connects to the video decoder chip through a video decoder interface.

15. The electronic album of claim 9, wherein the multiplexer connects to the screen control chip through an image formation interface and further connects to the computer screen.

16. The electronic album of claim 10, wherein the storage media device interface is located on the casing of a computer monitor.

17. A electronic album comprising an electronic album control chip installed in a conventional computer screen for processing analog signals and displaying digital images, wherein the electronic album control chip includes:
an image storage media device controller for controlling image reading of an image processing device;
a power management unit for controlling power utilization in the electronic album control chip;
a frame buffer memory controller for controlling a connected buffer memory that retrieves image files;
a connection device controller controlling an external image storage device reader;
a digital signal processor for decompressing digital images in the electronic album control chip and converting to a picture formation mode for the computer screen;
a inter-IC bus connecting to an external microprocessor for processing control signals;
a digital video signal output port for outputting image files in the electronic album control chip;
a multiplexer for receiving signals from a video decoder chip and output signals from the digital video signal output port, and connecting to a screen control chip for displaying pictures on the computer screen;
a on-screen display chip for receiving control signals from the microprocessor and transmitting the signals to a screen control chip; and
a differential signal receiver for receiving digital signals from a connecting external device and transferring the signals to the screen control chip..

18. The electronic album of claim 17, wherein the image storage media device controller connects to the image processing device through a storage media device interface,

19. The electronic album of claim 17, wherein the frame buffer memory controller connects to the buffer memory through a memory interface.

20. The electronic album of claim 17, wherein the connection device controller connects to the image storage device reader through a connection port interface.

21. The electronic album of claim 17, wherein the inter-IC bus connects to the microprocessor through a inter-IC bus interface.

22. The electronic album of claim 17, wherein the multiplexer connects to the video decoder chip through a video decoder interface.

23. The electronic album of claim 17, wherein the multiplexer connects to the screen control chip through an image formation interface and further connects to the computer screen.

24. The electronic album of claim 17, wherein the signals received by the differential signal receiver include a transmission-minimized differential signaling and a low-voltage differential signaling.

25. The electronic album of claim 18, wherein the storage media device interface is located on the casing of a computer monitor.
